(19) United States
(12) Patent Application Publication
(10) Pub. No.: US 2013/0290324 A1
(43) Pub. Date: Oct. 31, 2013

(54) CATEGORIZING AND RANKING TRAVEL-RELATED DATABASE QUERY RESULTS

(71) Applicant: AMADEUS S.A.S., Sophia Antipolis (FR)

(72) Inventors: Sebastien Gibergues, Biot (FR); Benedicte Isnardon, Cannes (FR); Nicolas Maillot, Biot (FR); Marc Patoureaux, Grasse (FR); Alex Prengere, Antibes (FR); Charles Antoine Robelin, Antibes (FR); Luc Viguié, Nice (FR)

(73) Assignee: Amadeus S.A.S., Sophia Antipolis (FR)

(21) Appl. No.: 13/674,505

(22) Filed: Nov. 12, 2012

Related U.S. Application Data
(60) Provisional application No. 61/638,733, filed on Apr. 26, 2012.

(51) Int. Cl. G06F 17/30

(52) U.S. Cl. 707/731; 707/E17.064

(57) ABSTRACT

Methods, systems, and computer program products for processing database query results. Database query results are retrieved from a database. The database query results are classified according to multiple, distinct categories and at least one of the database query results for each of the multiple categories is stored as a featured result and then provided to a client device upon receipt of a travel search request from an end user of the client device.

### CROSS-REFERENCE TO RELATED APPLICATIONS

The present application claims the benefit of Provisional Application No. 61/638,733, filed Apr. 26, 2012, which is hereby incorporated by reference herein in its entirety.

### TECHNICAL FIELD

The invention generally relates to computers and computer software, and in particular to methods, systems, and computer program products for categorizing and ranking specific travel-related database query results as featured results for display by a travel service provider to an end-user customer, as well as corresponding computer program products.

### BACKGROUND

Searching features can be a factor that distinguishes travel service providers, such as online travel agents or agencies, and may cause on-line customers to prefer one travel service provider over another travel service provider. Travel search results supplied at e-commerce websites of travel service providers typically offer every possible travel recommendation in the results responsive to a search query. The travel recommendations (e.g., flight solutions with a fare in the context of air travel) may not correspond to travel recommendations that a trained and seasoned travel agent would propose to a customer in this type of transaction.

A customer may be overwhelmed and/or confused by the sheer number of travel recommendations embodied in the query results, which thereby hinders customer selection. A customer is unlikely to be a travel expert. Due to the complexity, the customer may have difficulty in establishing personal selection criteria and selecting a travel recommendation from among the many similar travel recommendations. This problem of displaying an excessive number of travel recommendations to the customer may lower the conversion rate (i.e., the number of purchases divided by the number of views) and lessen the effectiveness of the query results. Prospective customers who have difficulty in making a decision may be paralyzed by the excessive number of travel recommendations offered by the travel service provider for their selection in the fare search results, and may delay their purchase as a result. Presenting an excessive number of travel recommendations to the online customer may also adversely impact customer satisfaction with the travel service provider and thereby represent another problem. The degree of satisfaction may depend more on the perception of missed opportunities than on the actual quality of the selected product. A live travel agent, who plays an advisory role in offline travel booking services, may select travel recommendations to present to the customer. However, this type of expert assistance is absent from e-commerce travel websites because of the cost of providing the live travel agent.

Thus, improved systems, methods, and computer program products for processing and displaying travel-related search results are needed that assist in the customer to select an option from among a large number of available options.

### SUMMARY

In one embodiment, a method includes classifying a plurality of database query results at a computer system to populate each of a plurality of categories with a respective given number of the database query results, and communicate the respective given number of the database query results in each category from the computer system to a client device.

In one embodiment, a system includes a processor and program code configured to be executed by the processor to cause the processor to classify a plurality of database query results to populate each of a plurality of categories with a respective given number of the database query results, and to communicate the respective given number of the database query results in each category from the computer system to a client device.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a block diagram showing a processing and database system.

FIG. 2 is a high level functional diagram of the processing and database system of FIG. 1.

FIG. 3 is a flow chart of a featured results selection algorithm that may be executed by the processing and database system.

FIG. 4 is a diagrammatic view of a web page presenting featured results determined by the selection algorithm of FIG. 3.

FIG. 5 is another diagrammatic view of a web page presenting featured results determined by the selection algorithm of FIG. 3.

FIG. 6 is a diagrammatic view of a web page for entering a travel search query in order to initiate the selection algorithm of FIG. 3.

FIG. 7 is a diagrammatic view of a web page presenting the featured results determined by the selection algorithm of FIG. 3 in response to the travel search query entered using the web page of FIG. 6.

FIG. 8 is a diagrammatic view of a web page presenting a set of featured results resulting from selection of one of the categories in FIG. 7.

FIG. 9 is a diagrammatic view of a web page for entering a travel search query in order to initiate the selection algorithm of FIG. 3.

FIG. 10 is a diagrammatic view of a web page presenting the featured results determined by the selection algorithm of FIG. 3 in response to one type of travel search query entered using the web page of FIG. 9.

FIG. 11 is a diagrammatic view of a web page presenting the featured results determined by the selection algorithm of FIG. 3 in response to the search query entered using the web page of FIG. 9.

### DETAILED DESCRIPTION

Embodiments of the invention may be implemented by a processing and database system, such as a computerized reservation system. In the context of air travel, the processing and database system may be configured to respond to a travel search query received from a travel service provider by identifying travel recommendations that satisfy the travel search query. The processing and database system may be configured to identify travel recommendations and recommendations for a single airline. The processing and database system may be embodied in a global distribution system that identifies travel recommendations for multiple airlines. The embodiments of the invention facilitate selecting a particular travel recommendation from among a larger number of possible travel recommendations and then communicating the travel recommendations to a travel service provider, such as a travel agent and a travel agency, for presentation or display to a customer.

Travel service providers may interact with the processing and database system to search for travel recommendations responsive to a travel search query. The travel search query may originate from a customer of the travel service provider. In response to the receiving the criteria (e.g., origin, destination, travel dates, booking class, etc.) embodied as data in the travel search query, the processing and database system may retrieve pre-computed travel recommendations from storage (e.g., a memory) that satisfy the terms in the travel search request. Before displaying the matching travel recommendations, the processing and database system may apply logic to classify the travel recommendations contained in the search results (also referred to herein as results or database query results) as belonging to one or more categories. For example, a travel recommendation returned by the travel search query may be classified or categorized as belonging to a cheapest travel recommendation category or to a fastest travel recommendation category.

The travel recommendations in at least one of the categories may be ranked or sorted based on a ranking, and then included in a subset characterizing the sorted category. Each subset may include a given number of travel recommendations (e.g., the top N ranked travel recommendations) in the corresponding category sorted by the ranking condition. After categorizing and optionally ranking, the travel recommendations for each category may be communicated to the travel service provider and then may displayed by the travel service provider to a customer as featured results. The featured results may then be presented by the travel service provider to its customer, for example, in a web page visible on a display accompanied by an invitation to make a particular selection within a category. For example, a unitary travel recommendation may be selected for each of multiple categories and then this group of travel recommendations may be simultaneously presented by the travel search provider to a customer.

By limiting the choices displayed to the customer to a fewer than all possible travel recommendations, an improved display of results with higher value to the customer of a travel service provider is achieved. The customer is not overwhelmed with excessive choices and the traveler interfacing with the travel service provider does not to sift through hundreds of travel recommendations. The processing of the search results removes less desirable travel recommendations based upon suitable logic and, thereby, eliminates less attractive travel recommendations.

By using a combination of categorizing and ranking travel recommendations to be displayed or presented to the customer, the operation of a search results selection formula or algorithm may be made less transparent. In addition, selection algorithm performance on future search results may be improved by “auto learning” or predictive methods based on a variety of data associated with past customer behavior stored in databases accessible by the system. To further improve customer confidence in the presented travel recommendations, embodiments of the invention may also qualify each proposal with a “credibility stamp” as a confidence indicator that may provide a tangible source of confidence to the customer.

The processing and database system may consider past customer choices when scoring or ranking the relevance of travel recommendation search results. In the specific context of air travel, search results may be obtained from publicly and privately negotiated rate databases and then ranked, at least in part, based on business/market intelligence, such as previous sales data for past customers, booking data for past customers, ticketing data for past customers, and demand data for similar flights. For example, customers or travel agents who searched for flights between a particular origin and destination pair may have demonstrated selection patterns that provide insight regarding which flights are most likely to be of interest and relevant to a current system user seeking to book and/or ticket a flight. This history of which flights are more likely (i.e., have a relatively high historical probability) to be selected by a customer requesting a search with a similar set of search parameters may thereby be used to sort flight search results and narrow down the number of travel recommendations to be presented to the customer. Flights that are historically less likely (i.e., have a relatively low probability) to be selected by a customer may be filtered out of the displayed results to reduce visual clutter and to provide the customer with a more manageable set of travel recommendations as featured results.

The categories may include displaying a travel recommendation that is most popular to past customers as a featured result, travel recommendation with an overall fastest or shortest duration as a featured result, a travel recommendation that is part of an exclusive offer which the travel service provider has negotiated with one or more selected airlines as a featured result, a travel recommendation that is the cheapest as a featured result, a last or most recently booked travel recommendation across all distributers for the requested travel date, origin, and destination as a featured result, and/or a travel recommendation sponsored by a travel service provider as a featured result.

In an alternative embodiment, a qualification flag or sense-of-urgency indicator may be communicated from the processing and database system to the travel service provider for display to the customer along with the featured results to promote decision making The sense-of-urgency indicator may be representative of the popularity of one or more of the flight itineraries in the featured results. For example, the processing and database system may cause an indication of a number of travelers who have booked a particular flight itinerary to be communicated as a sense-of-urgency indicator to the travel service provider for display to the customer. Alternatively, the processing and database system may cause a time stamp indicating when the latest ticket was booked for a flight or a similar flight to be communicated as a sense-of-urgency indicator to the travel service provider for display to the customer. Alternatively, the processing and database system may cause a warning indication of how many seats are currently available for a flight itinerary to be communicated as a sense-of-urgency indicator to the travel service provider for display to the customer. The processing and database system may also cause multiple sense-of-urgency indicators to be simultaneously returned for display to the customer.

While the embodiments of the invention will address featured results in the context of travel recommendations as the featured results, the features results may also be based upon travel solutions that do not have an associated fare or price, or upon travel search queries. A generic term, result, is also used herein when referring to featured results.

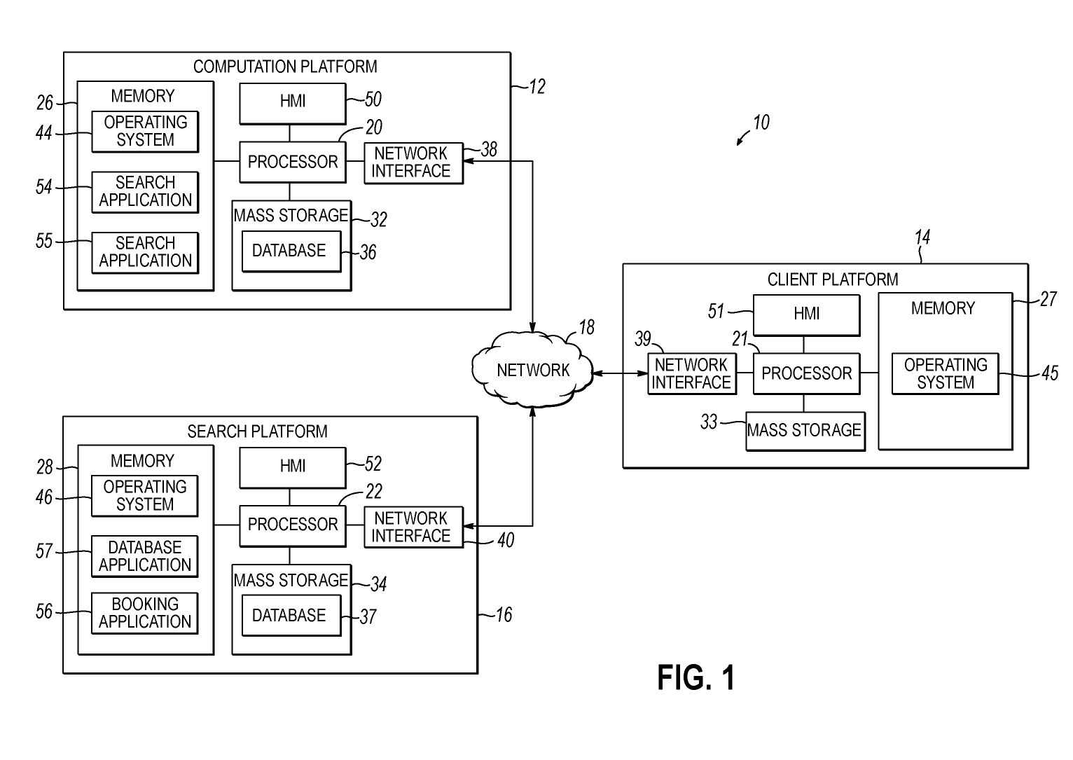

With reference to FIG. 1 and in accordance with an embodiment of the invention, an exemplary processing and database computer system 10 includes a computation platform 12, a client platform 14 that is managed by the travel service provider and that is configured to receive travel search queries from customers, and a search platform 16. The platforms 12, 14, 16 are in operative communication with each other via a network 18. Computation platform 12 may include a processor 20, memory 26, a mass storage device 32, a network interface 38, and a Human-Machine Interface (HMI) 50. Client device or platform 14 may include a processor 21, memory 27, a mass storage device 33, a network interface 39, and a HMI 51. Search platform 16 may include a processor 22, memory 28, a mass storage device 34, a network interface 40, and a HMI 52.

Each of the processors 20-22 may include one or more processing circuits selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog and/or digital) based on operational instructions that are stored in the associated platform memory 26-28. Each of the memories 26-28 may comprise a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, and/or any other device capable of storing digital information. Each of the mass storage devices 32-34 may comprise a single mass storage device or a plurality of mass storage devices including, but not limited to, hard drives, optical drives, tape drives, non-volatile solid state devices and/or any other device capable of storing data, such as a database structure 36, 37.

Network interfaces 38-40 may employ one or more suitable communication protocols for communicating over the network 18, such as User Datagram Protocol/Internet Protocol (UDP/IP), and/or Transmission Control Protocol/Internet Protocol (TCP/IP). The network interfaces 38-40 may connect to the network 18 via a hardwired link, such as an IEEE 802.3 (Ethernet) link, a wireless link using a wireless network protocol, such as an 802.11 (Wi-Fi) link, or any other suitable link that allows the platforms 12, 14, 16 to interface with the network 18. Network 18 may include a plurality of interconnected networks, such as one or more Local Access Networks (LANs), Wide Access Networks (WANs), and/or public networks, such as the Internet.

Each of the processors 20-22 may operate under the control of a respective operating system 44-46, which may reside in the corresponding memory 26-28 of the respective platforms 14, 16, 18. The operating system 44-46 may manage the computer resources of respective platforms 14, 16, 18 so that computer program code embodied as one or more computer software applications 54-57 residing in memory 26-28 may have instructions executed by the processor 20-22. An HMI 50-52 may be operatively coupled to the processor 20-22 of the respective platforms 12, 14, 16 in a known manner. The HMI 50-52 may include output devices, such as alphanumeric displays, a touch screen, and other visual indicators, and input devices and controls, such as an alphanumeric keyboard, a pointing device, keypads, pushbuttons, control knobs, etc., capable of accepting commands or input from an operator and transmitting the entered input to the processor 20-22.

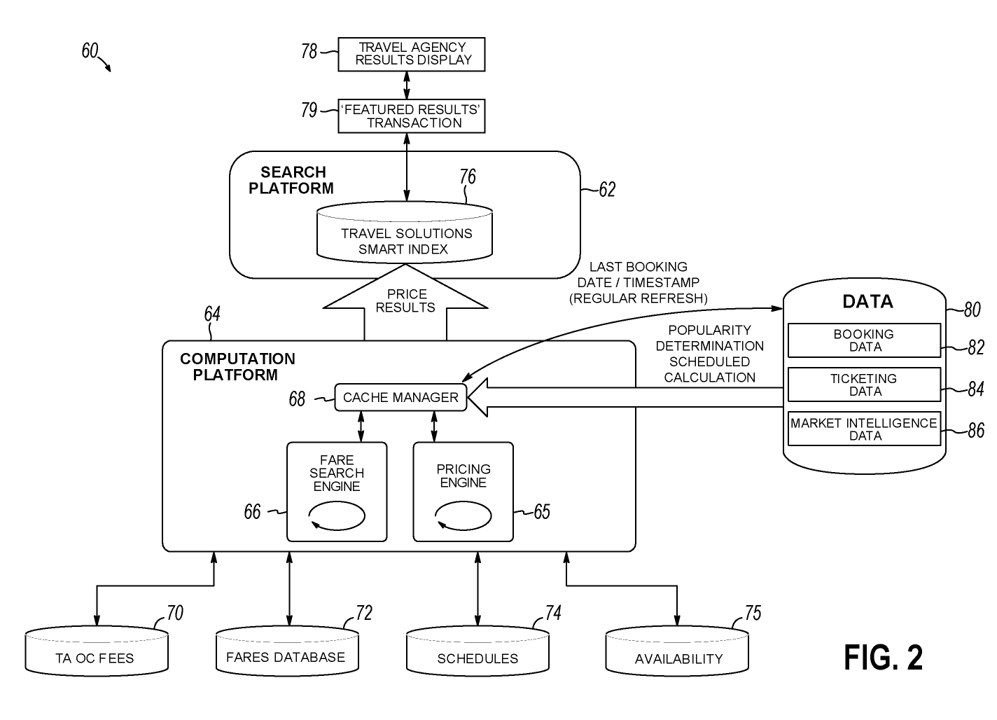

With reference to FIG. 2, a processing and database system 60 comprises a search platform 62 representing an embodiment of the search platform 16, and a computation platform 64 representing an embodiment of the computation platform 12. The functions shown in FIG. 2 that comprise the processing and database system 60 may be provided by one or more search applications 54, 55 hosted by the system platform 12, and/or may be provided by applications running on separate hardware platforms connected through a network or other communication medium. The computation platform 64 includes a cache manager module 68, a pricing engine plug-in 65, and a fare search engine plug-in 66. The cache manager module 68 manages re-computation orders arriving from the search platform 62, as well as plug-ins 65, 66, and returns computed database query results to the search platform 62 for use in responding to travel search queries arriving from the user platform 14. The computations performed by the computation platform 64 are not synchronous with travel search requests made by end users to the search platform 62 (i.e., the computations of the computation platform 64 are made independently from end-user requests arriving at the search platform 62). The search platform 62 stores the pre-computed query results and the featured results in anticipation of communicating same to the client platform 14 when, for example, the client platform receives a travel search request from an end user.

The computation platform 64 is configured to compute numerous travel recommendations within a given time frame and to provide these travel recommendations as pre-computed data to the search platform 62. The computation may be triggered by batch re-computation orders communicated to the computation platform 64 from an external source. The fare search engine plug-in 66 may run continuously so that the travel recommendations with the lowest fare are constantly updated by the computation platform 64 and refreshed in the search platform 62. In one embodiment, the travel recommendations stored by the search platform 62 may thereby reflect real-time or near real-time fare pricing. Additionally or alternatively, an intelligent approach may be used to update the pre-computed database query results according to a different schedule. In addition, market intelligence data (e.g. popularity) may be used by the computation platform 64 to perform optimal price computations.

A representative computation platform is disclosed in U.S. application Ser. No. 13/113,008, filed May 20, 2011, which is hereby incorporated by reference herein in its entirety. A representative search platform is disclosed in U.S. application Ser. No. 13/185,417, filed Jul. 18, 2011, which is hereby incorporated by reference herein in its entirety. Recomputation orders may be generated externally (e.g., once every 24 hours, as is the case currently) or the cache manager of the computation platform itself might make “intelligent” decisions about when to recompute search results, based on the probability that the stored results have become inaccurate. A representative external re-computation trigger platform for providing intelligent updating is disclosed in U.S. application Ser. No. 13/585,286, filed Aug. 14, 2012, which is hereby incorporated by reference herein in its entirety. A representative computation platform, a representative search platform, and a representative re-computation platform are also disclosed in U.S. application Ser. No. 13/669,993, filed Nov. 6, 2012, which is hereby incorporated by reference herein in its entirety

For search requests including a unique itinerary requiring data that has not been pre-computed or recently updated, the pricing engine plug-in 65 may be used by the computation platform 64 to compute a unique price upon the internal request of the cache manager module 68. The uniquely priced itinerary may then be provided to the search platform 62.

The pricing engine plug-in 65 and fare search engine plug-in 66 of the computation platform 64 may be in operative communication with one or more databases that contain data relating to airline flights, such as a Travel Agency Originating Commission (TAOC) fee database 70, a flight fares database 72, a flight schedules database 74, and a flight availability database 75. The TAOC fee database 70 may include information regarding ancillary services filled by an online travel agency having a pre-existing relationship with the TOSS operator. The fares database 72 may include published and negotiated fares, e.g., published airline fares and fares negotiated by a travel agency. Similarly, the schedules database 74 may include airline flight schedules, and the flight availability database may include information regarding the availability of flights and/or open seats on the flights. Each of the databases 70, 72, 74, 75 may include records containing proprietary data that is accessible within the processing and database system 60, but that is not reachable from outside the system 60. Each of the databases 70, 72, 74, 75 may also include data available from publically accessible databases. Two or more of the databases 70, 72, 74, 75 may be combined into a single database, such as the schedules database 74 and the flight availability database 75.

To pre-compute travel search queries, one or more of the fare search engine plug-in 66 (which may process numerous itineraries at once) and/or pricing engine 65 (which may process a single itinerary at a time) queries the databases 70, 72, 74, 75 to perform a lowest-fare search process and delivers the search results. In an embodiment of the invention, the plug-ins 65, 66 of the computation platform 64 may return results that include price, availability, and schedule data for flights matching the search terms in the search request. Each set of search results may be based upon an origin/destination pair and a travel date.

To facilitate determining the popularity of a travel recommendation, last booking date, and/or last timestamp indexing functions, the cache manager 68 may be in operative communication with a Last Booking Date/Timestamp (LBDT) database 80. The LBDT database 80 may maintain, and/or have access to, one or more proprietary databases containing historical data relating to the travel recommendations booked by past system users. In the exemplary embodiment shown in FIG. 2, the LBDT database 80 includes a booking information database 82, a proprietary ticketing database 84, and a market and/or business intelligence database 86. The booking information database 82 may include all Passenger Name Record (PNR) data for travel bookings performed by users via the processing and database system 60. The proprietary ticketing information database 84 may include data relating to all tickets sold via the travel booking system. The data in the proprietary booking information and ticketing information databases 82, 84 may be data captured by the processing and database system 60 as recommendations are booked and bookings are ticketed. This data may therefore be data that is not directly available to systems outside the processing and database system 60. The market and/or business intelligence information database 86 may include an inventory of all globally accessible PNR databases, which may be operated, for example, by travel agencies, airlines, and/or other travel booking systems.

The determination of the featured results by the computation platform 64 is described hereinbelow.

The search platform 62 includes a travel solutions smart index (TSSI) 76 that indexes and/or stores search results and featured results received from the computation platform 64. The index 76 may comprise an in-memory storage (not shown). Search results and featured results may be provided to the index 76 by the cache manager 68, which manages the database query results returned by the pricing engine and fare search engine plug-ins 65, 66. The cache manager 68 regularly refreshes data in the search platform 62 from the LBDT database 80 so that as booking, ticketing, and market and/or business intelligence data is updated, the data in the index 76 may be kept current in, for example, real-time or near real-time.

A featured results transaction 79 between the search platform 62 and the client platform 14 to, for example, respond to a travel search request from an end user may interrogate the featured results stored by the travel solutions smart index 76 to determine the one or more selected results in each of one or more categories, with the selected results representing the “best” or “top” choices available for a given primary search category. The transaction 79 communicates the featured results to the client platform 14 for presentation and display to the end user. The stored data may be re-calculated and/or refreshed at regular intervals so that search results are ranked according to the latest booking and ticketing data available. By providing a local database (which may be an in-memory storage at the search platform 62) within the processing and database system 60 that hosts and indexes search result data, the index 76 may be used to provide end users with comparatively fast response times to search requests. The perceived performance of the system may thereby be improved as compared to systems that must retrieve travel recommendation information from external databases each time a search request is submitted by a system user.

Travel service providers may interact with the search platform 62 through a website to search for travel recommendations in response to an inquiry from a customer. Generally, a website is a collection of interconnected web pages that are typically located on a common server, and prepared and maintained as a collection of information. In response to a travel search query received from a travel service provider, a featured result transaction may be provided to a display function 78, which in turn provides the featured results in a readable format on a display to the requesting entity. The requesting entity may be a travel agency website, the travel recommendation booking application 56, or any other application that a system user or customer might use to search for and book travel recommendations. The display function 78 may also provide an Application Programming Interface (API) that is used as an interface to the processing and database system 60 by external resources or applications, such as the travel recommendation booking application 56, a web server application (not shown), or any other suitable application.

In developing search results selection in order to selected the featured results, indexing, and/or ranking formulas, all possible sources and types of data may be considered in the preliminary analysis of historical travel recommendation selection data, and one or more formulas, algorithms, rules, and/or criteria may be applied. Based on this analysis, travel recommendation characteristics may be selected based on their effect on, or correlation to, customer selections. Travel recommendation data analyzed may include, but is not limited to, ticket price, travel time, airline, and the number of times that the travel recommendation has been booked, to name but a few parameters. By way of example, the number of times that a travel recommendation has been booked in the past may be used to define a category of travel recommendation classification, as well as to rank search results within this category or another different category. The system may then define all possible criteria that could distinguish the booked recommendation or recommendations from other alternative travel recommendations that were not booked or that were booked at a lower selection rate. For example, flight booking rates may be correlated to flight duration, departure time, return time, number of stops, total price, airline, originating airport, destination airport, departure day of the week, return day of the week, departure date, return date, etc. Each one of these travel recommendation characteristics may be combined to determine a composite value that correlates to the frequency with which the corresponding travel recommendation is selected. This value, in turn, may be one of several used to select the featured results of a travel recommendation search.

The categories used to distinguish booked travel recommendations are not limited to any of the aforementioned lists, and may include any criterion that characterizes a travel recommendation. The system may analyze the data set, and select relevant categories based on the analysis. This analysis may take into consideration the different dimensions of the data set, and balance the rating depending on the amount of data available for each data point. If there is not enough data for a given data point, the process may abstract or interpolate the variable until the variable is represented by a significant amount of data. The selected categories may be applied to search results to determine which results to present to a system user as the featured results. Influencing category combinations may also be grouped to provide diversity in the proposed travel recommendation selections provided to the system user.

The raw pre-computed query or search results may be filtered to reduce the number of results during the pre-computation phase of the process. A first filter retains N results corresponding to the N most popular results, N fastest results, etc. One reason to keep N results for a category may be that, during the rest of the process, some results may fail a check and be discarded due to lack of availability, an absence of eligibility, or another reason. The existence of N results at the beginning of the process ensures (statistically speaking) that at least one result is retained after the checks are applied. A second filter is effectively applied during the categorization and amounts to a sorting. For example, from among the number of most popular results that remain from the initial N after the checks, the most popular result is selected as the featured result for this category. As another example, from among the fastest results that remain from the initial N results after the checks, the fastest result is selected as the featured result for this category.

The categories used by the computation platform 64 to classify the pre-computed travel search query results may include, but are not limited to, the following categories.

Fastest—The computation platform 64 may process the pre-computed database query results to determine of travel recommendations having the shortest elapsed times in transit for each origin/destination pair and date. The travel recommendations constituting the results may be sorted in the determination according to transit time from the fastest travel recommendation to the slowest travel recommendation. The elapsed time used as a factor to sort this category may include the sum of the flight time(s) for a recommendation and the ground time between any connections between flights. A limited and specific given number of travel recommendations for the category is stored in the index 76 at the search platform 62. In one embodiment, only a single travel recommendation having the shortest elapsed time in transit for the origin/destination pair on each travel date may be designated as a featured result stored by the index 76 for this category and then communicated in the featured results transaction 79 in response to a travel-related search query initiated by, for example, an end user. Alternatively, a plurality of the fastest travel recommendations (e.g., N=5) can be designated as the featured result and stored in the index 76. Alternatively, a secondary ranking, such as cost or popularity, may be used as a secondary factor to further sort multiple travel recommendations.

Popular—The computation platform 64 may process the computed database query results to determine travel recommendations that have the highest popularity among past customers. In representative embodiments, the popularity of the travel recommendations constituting results may be based upon either most frequent booking by past customers or most frequent ticketing by past customers. A limited and specific given number of the travel recommendations for the category is stored in the index 76 at the search platform 62. In one embodiment, only a single travel recommendation that is the most popular for the origin/destination pair on each travel date may be designated as a featured result stored by the index 76 for this category and then communicated in the featured results transaction 79 in response to a travel-related search query initiated by, for example, an end user. Alternatively, a plurality of the most popular travel recommendations (e.g., N=5) can be designated as the featured result and stored in the index 76.

This category may employ different levels of granularity for the compiled booking and ticketing data, such as booking or ticketing worldwide, booking or ticketing only within a predefined market, or booking or ticketing only at a point of sale. The granularity levels may be use in combination to produce a composite popularity rating. The popular category may rely upon relative recency of the bookings or ticketing, which may be weighted to better capture customer behavior. For example, a popularity weighting scheme can be used to reflect the fact that bookings or ticketing made further in the past (e.g., 6 months ago) have be given the same importance in the weighting as bookings or ticketings made recently (e.g., 2 days ago). The same logic may be applied if travel search queries, instead of bookings or ticketing, are used to determine the most popular recommendations. Multiple travel recommendations in this category may be sorted for display strictly using the classification provided by the category (i.e., from most popular travel recommendation to least popular travel recommendation), or may be sorted in combination with another secondary factor, such as traveler-desired route, carrier, schedule, and/or cost, to qualify the featured results for display.

Exclusive—The computation platform 64 may process the computed database query results to determine travel recommendations that include ancillary services negotiated with one or several airlines by an affiliated travel agency. Exemplary ancillary services may include any additional service that is exclusive to the traveler such as, for example, complementary lounge access, upgraded meals, and/or seat upgrades. The affiliated travel agency may be one or more selected travel agencies that are provided access to the processing and database system 60. In representative embodiments, the popularity of the travel recommendations constituting results may be based upon either most frequent booking by past customers or most frequent ticketing by past customers. A limited and specific given number of the travel recommendations for the category is stored in the index 76 at the search platform 62. In one embodiment, only a single travel recommendation includes a negotiated ancillary service for the origin/destination on each travel date may be designated as a featured result stored by the index 76 for this category and then communicated in the featured results transaction 79 in response to a travel-related search query initiated by, for example, an end user. Alternatively, a plurality of travel recommendations (e.g., N=5) can be designated as the featured result and stored in the index 76. Multiple travel recommendations in this category may be ordered for display based on the lowest cost recommendation matching the airline's fare attached to these ancillary services—i.e., based on total cost of the travel recommendation and/or on the cost of the associated air fare alone. An alternative secondary factor, such as popularity, may be used for sorting.

Cheapest—The computation platform 64 may process the computed database query results to determine travel recommendations that are the cheapest or lowest cost. The cost used in the determination may consider published fares and private fares negotiated between one or more airlines and participating travel agencies. A limited and specific given number of the travel recommendations for the category is stored in the index 76 at the search platform 62. In one embodiment, only a single cheapest travel recommendation of lowest cost for the origin/destination on each travel date may be designated as a featured result stored by the index 76 for this category and then communicated in the featured results transaction 79 in response to a travel-related search query initiated by, for example, an end user. Alternatively, a plurality of the cheapest travel recommendations (e.g., N=5) can be designated as the featured result and stored in the index 76. In an alternative embodiment, the price of each travel recommendation may be used instead of fare. In case of travel recommendations with fares that are priced equally, the travel recommendations may be ordered for display based upon popularity, such as described with respect to the “Popular” category described above.

Last Booked—The computation platform 64 may process the computed database query results to determine travel recommendations that were most recently booked. A limited and specific given number of the travel recommendations for the category is stored in the index 76 at the search platform 62. In one embodiment, only a single most-recently booked travel recommendation for the origin/destination on each travel date may be designated as a featured result stored by the index 76 for this category and then communicated in the featured results transaction 79 in response to a travel-related search query initiated by, for example, an end user. Alternatively, a plurality of most-recently booked travel recommendation travel recommendations (e.g., N=5) can be designated as the featured result and stored in the index 76. The “last booked” category may be determined based upon the relative recency of the bookings If a specific customer of the travel agent has booked a trip having the same or similar characteristics in the past—e.g., between the same origin and destination—the “last booked” option may also display flight options last chosen by the specific customer or may be biased by the specific customer's historical identical or similar bookings.

Sponsored—The computation platform 64 may process the computed database query results to determine travel recommendations that have been selected by a sponsoring entity, such as a travel agency were most recently booked. A limited and specific given number of the travel recommendations for the category is stored in the index 76 at the search platform 62. These travel recommendations may include a particular routing, carrier, or fare, and may be based on a negotiated deal between the sponsoring entity and the travel recommendation provider, such as, for example, a higher commission paid from an airline to a travel agency. In one embodiment, only a single sponsored booked travel recommendation for the origin/destination on each travel date may be designated as a featured result stored by the index 76 for this category and then communicated in the featured results transaction 79 in response to a travel-related search query initiated by, for example, an end user. Alternatively, a plurality of sponsored booked travel recommendation travel recommendations (e.g., N=5) can be designated as the featured result and stored in the index 76.

In an embodiment of the invention, each category (other than “most popular” category) of search results may be ranked according to popularity ranking as a measure of relevance. That is, multiple top-ranked results within a category may be sorted according to a ranking, such as popularity, as a measure of relevance. If there are several results in a category that are indistinguishable (e.g., having the same (shortest) transit time or having the same popularity), a secondary factor or criterion may be used (e.g., price, popularity, transit time, time of day, etc) for determining the feature result. As a specific example, the least expensive travel recommendation from indistinguishable multiple travel recommendations may be specified by the computation and stored as a featured result for the category of fastest featured result. Alternatively, another secondary factor or criterion may be used if needed, or one of the results may be selected at random considering that they are all relevant and attractive.

A top result or several top results from this ranked subset may then be displayed to the customer as featured results in a results display 78. In this way, the number of choices presented to the customer may be limited to a manageable number. This restriction may reduce anxiety in the customer caused by an overwhelming number of choices, and thereby facilitate quicker, less stressful decision making

In addition to the number of past customers who have booked a particular flight, the LBDT database 80 may also include information regarding the time the last ticket for a particular itinerary was booked, the number of remaining seats for a particular ticketing option, and popularity related to a specific criteria, such as the number of travelers who booked a ticket or were ticketed for a certain date, time, price, destination, etc. Featured results may be displayed on a map as the most popular, fastest, etc. destinations based on a time of year (e.g., where travelers are booking flights in March); based upon an originating location (e.g., where are travelers flying to from Chicago); based upon price (what is the cheapest destination), or any other travel parameter.

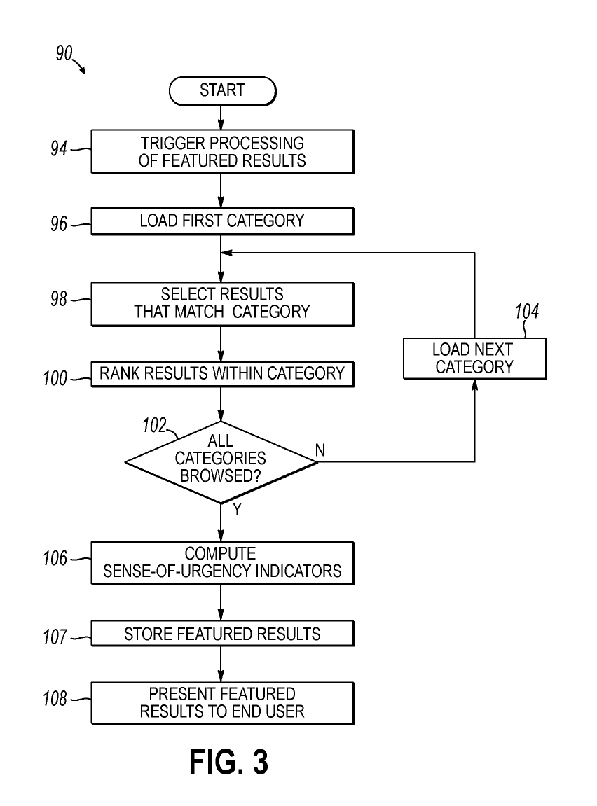

Referring now to FIG. 3, a flow chart 90 illustrates a featured results selection algorithm in accordance with an embodiment of the invention. In block 94, the computation of featured results by the computation platform 64 is triggered. In block 96, the computation platform 64 loads a first category for determining featured results. The first category may be classified by one of the categories discussed above, such as the travel recommendations having the lowest elapsed times, popularity, the presence of exclusive offers, cost, last booked, and/or sponsorship. In block 98, the computation platform 64 determines specific search results from a larger number of raw search results that match the loaded category and then proceeds to block 100.

In block 100, the computation platform 64 may rank the results within each category to provide an ordered or sorted arrangement. Specifically, search results within each category may be ordered or sorted relative to each other according to the category classification—e.g., in an order or rank of fastest, cheapest, highest popularity, etc. As examples, travel recommendations in the elapsed time category may sorted or ordered be from shortest to longest, travel recommendations in the cost category may be sorted or ordered from cheapest to most expensive, travel recommendations in the popular category may be sorted or ordered according to popularity, etc. Alternatively, the sorting or ordering may be based on a secondary factor, such as the popularity of the featured results in each category.

Considering the top N recommendations in each category, sorting may make use of market intelligence data to return the recommendations in a relevant order in all the cases. Booking count may also be associated with each recommendation.

In block 102, the computation platform 64 determines if all the categories of search results have been browsed. If not (“NO” branch of decision block 102), the computation platform 64 proceeds to block 104 and loads the next category for determining featured results. The processing and database system 60 then returns to block 98 to repeat the featured result selection process using the newly loaded category. If all the search result categories have been browsed for featured results (“YES” branch of decision block 103), the computation platform 64 proceeds to block 106. In block 106, sense-of-urgency indicators may determined for each featured result or group of results within a category. One or more travel recommendations and any sense-of-urgency indicators are communicated from the computation platform 64 to the search platform 62 and stored in the index 76 as featured results for future use in, for example, responding to travel search queries.

In block 108, the featured results and any associated sense-of-urgency factors may be communicated from the search platform 62 to the client platform 14 or other requesting entity via the display function 78. A search query prompting the communication of the featured results may originate from a web server application or a booking application 56 hosted on the search platform 14. In block 94, the search engine 64 retrieves search results from the index 76. The action prompting the retrieval may be a search query that originates from an end user of the client platform 14. In cases where the search query includes terms that do not match travel recommendations indexed in the index 76, the computation platform 64 may provide computed featured results to the index 76.

The displayed featured results may be used, for example, in pre-shopping as priced air travel recommendations. Before actually booking travel, an end user normally wants to educate himself or herself about available flights including current flight prices, without any commitment to actually book the flight.

The search result selection process may thereby apply one or more formulas to a given search request, with each formula corresponding to a particular category, by matching the search parameters to each formula's data set dimensions. The search result selection process may then rank the list of results produced by each formula and determine the top N results with the category. Each formula may correspond to a qualification category, and each proposed result may be qualified accordingly.

Each category may be associated with a qualification flag that can be returned as a sense-of-urgency flag together with the result. Other sense-of-urgency flags might be also returned with each featured result. Result formulas may have both qualitative and quantitative flags. In the case of a qualitative formula, a qualification flag may be fixed to identify a particular qualitative criterion associated with the formula. For example, the flag may identify the formula's category as being the cheapest or fastest available travel recommendation. In the case of a quantitative formula, the qualification flag may include a numerical parameter. For example, the qualification flag may be based upon the last booking time, such as the travel recommendation was last booked X minutes ago, as a sense-of-urgency feature associated with one or more of the travel recommendations in the featured results. As another example, the qualification flag may be based upon the frequency with which each travel recommendation in the feature results has been booked in the past, and supplied with the featured results as a sense-of-urgency feature. As yet another example, the qualification flag may indicate the number of seats remaining in inventory for each travel recommendation in the feature results as a sense-of-urgency feature supplied with the featured results. A given result may also belong to multiple categories. For example, a specific flight may be both the cheapest and fastest travel recommendation for a desired origination and destination pair, in which case the flight would be indexed as belonging in both categories. The search result qualification process may flag each result and lookup the numerical value in case of quantitative result, and the response may include a results selection including the respective qualification flags.

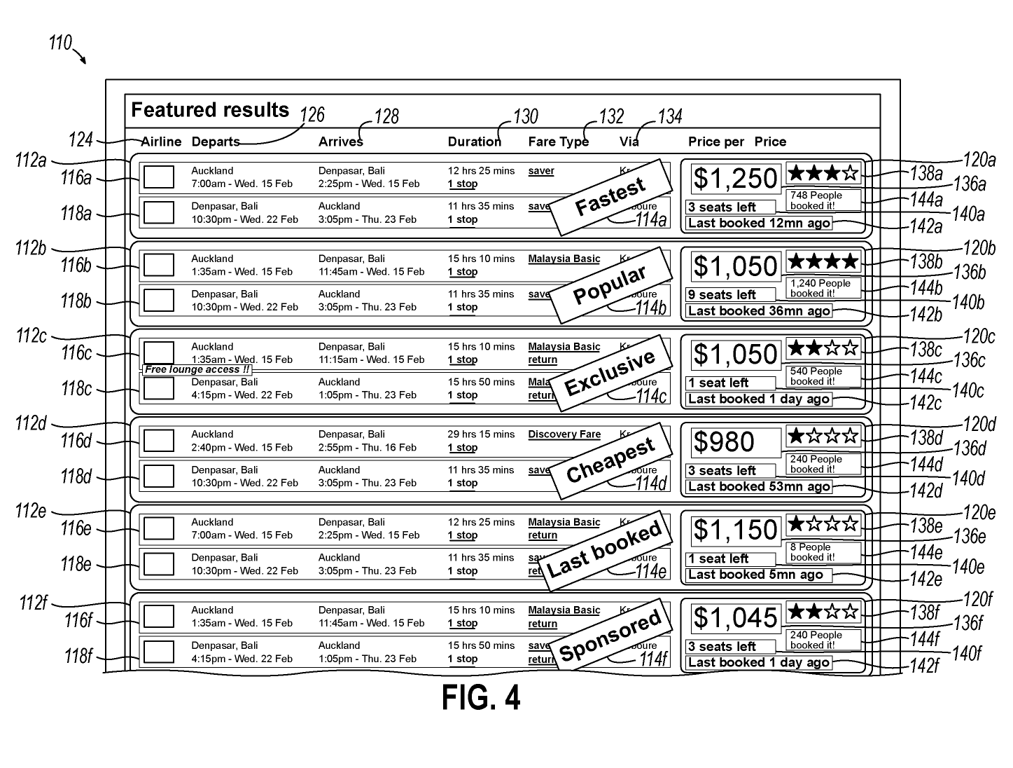

Referring now to FIG. 4, an exemplary featured results page 110, such as may be displayed by a browser application or an application on a mobile device (e.g., smartphone), provides the featured results in a plurality of windows 112a-112f each presenting a travel recommendation for a search result category. Although the search results page 110 as illustrated in FIG. 4 includes six search result category windows 112a-112f, embodiments of the invention may include any number of category windows, and the invention is not limited to a particular number of category windows. The number of featured results displayed in each of the category windows 112a-112f is also not limited to any particular number, and may be, for example, a single travel recommendation as a featured result. Each category windows 112a-112f in the representative embodiment includes a single travel recommendation as a featured result.

By way of another example of how featured results may be displayed, in response to a user selecting or hovering over a particular category, the system may expand the category window 112a-112f to show additional travel recommendations for that category. Thus, persons having ordinary skill in the art will understand that the web page illustrated in FIG. 4 represents only one exemplary way to display featured results, and embodiments of the invention are not limited to the display configuration shown. A person having ordinary skill in the art will appreciate that the recommendations in FIG. 4 are representative and that the travel recommendation(s) constituting each featured result will differ for the different categories. For example, the travel recommendation may be different for each of the different categories.

Each category window 112a-112f may include a category identifier flag 114a-114f that identifies the search results classification, a plurality of category windows 116a-116f, 118a-118f, and a price/availability information window 120a-120f. As shown in FIG. 4, the travel recommendation in each of the category windows 112a-112f includes a departure segment in windows 116a-116f and a return segment in windows 118a-118f, although other numbers of travel recommendations and/or segments may be displayed within the category windows 112a-112f. For example, embodiments of the invention may display a travel recommendation for a one-way trip having one or more segments, or multiple travel recommendations each having one or more segments. The segment windows 116a-116f, 118a-118f may include information regarding the corresponding travel recommendation, such as airline carrier 124, departing location 126, arriving location 128, duration 130, fare type 132, and any planned layover locations 134.

Each price/availability information window 120a-120f may include a price 136a-136f for the travel recommendations, a star ranking 138a-138f that may be determined based on the popularity of each travel recommendation (alternatively, customer feedback regarding each travel recommendation may also be considered in the determination), and one or more sense-of-urgency features. The sense-of-urgency features may include a qualification flag indicating the number of seats available 140a-140f, a qualification flag indicating the time the last seat was booked 142a-142f, and/or a qualification flag indicating how many travelers have booked the travel recommendation 144a-144f The selection of which, if any, sense-of-urgency features to display is discretionary. In alternative embodiments, only one of the sense-of-urgency features may be displayed with the travel recommendation, or fewer than all of the sense-of-urgency features may be displayed in conjunction with the travel recommendation.

In operation, a customer who wishes to search for and/or book a flight may interact with travel agency website using a web browser on computer, tablet, or smartphone (or a smartphone application) in a known manner. The travel agency website may be hosted by the client platform 14. A customer may enter an origin and destination pair and travel dates to the client platform 14, which receives the entered information and issues a search request to the search platform 62. In response to receiving the search parameters of the query, the search platform 62 may search for travel recommendations matching the entered information, as well as featured results corresponding to the travel search query as previously described with respect to FIGS. 2 and 3. The search platform 62 may then provide the search results and the featured results to the client platform 62. The requesting application may then display the results of the various categories as featured results page as described with respect to FIG. 4.

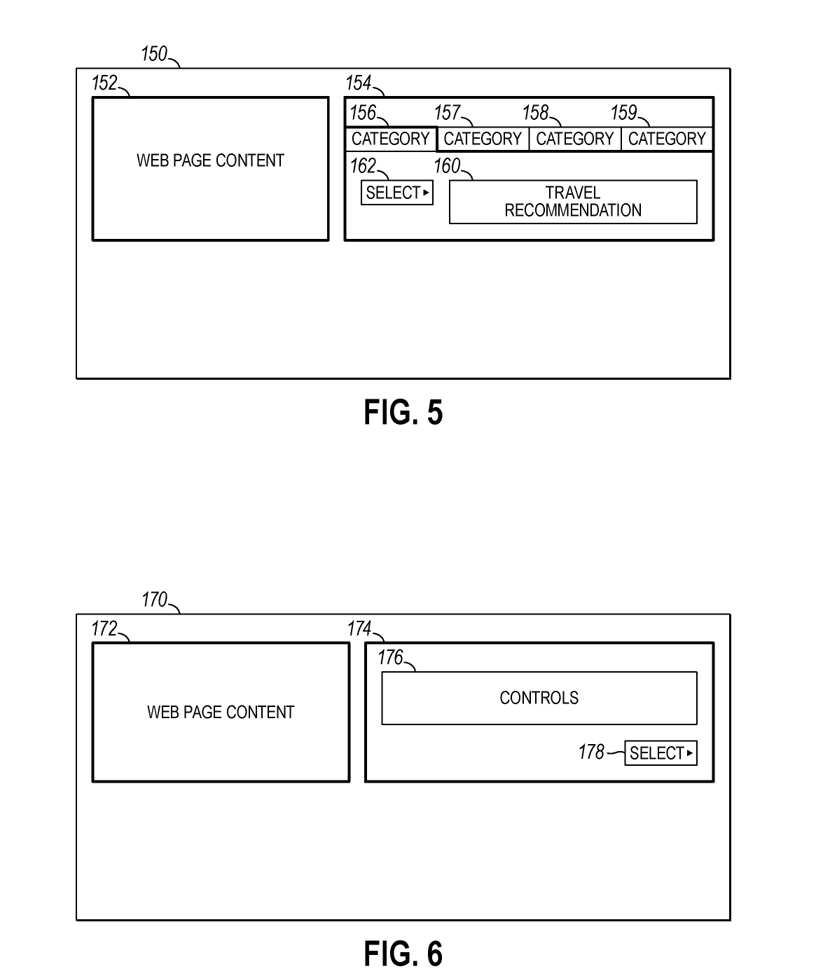

With reference to FIG. 5, a web page 150 is configured to display featured results determined by the selection algorithm (FIG. 3) on a display, screen, monitor, etc. While described as a web page, the display of featured results in FIG. 5 and as otherwise described herein may be provided by a tablet or smartphone application on a screen of the tablet or smartphone. The web page 150 includes content 152 that may comprise controls that facilitate user interaction, static images, animated images, hyperlinks, etc. In a region 154 of the web page 150, a plurality of categories 156, 157, 158, 159 are displayed. Each of the categories 156, 157, 158, 159 is a control or button that can be activated (e.g., clicked upon using the cursor of a pointing device) to perform an action and, more specifically, to select one of a plurality of different categories. A travel recommendation 160 representing a featured result determined using the selection algorithm described hereinabove and associated with the selected one of the categories 156, 157, 158, 159 is displayed in region 154. For example, the travel recommendation 160 may be the featured result for category 156. The travel recommendation 160 can dynamically change as the button selection changes so that the featured result for each category can be individually displayed. A select button 162 is present that permits the user of the web page 150 to select the displayed travel recommendation 160 in order to investigate more details of the travel recommendation 160, to book the travel recommendation 160, etc.

The travel recommendation 160 may represent the top or most relevant recommendation for category 156. In an alternative embodiment, more than one travel recommendation 160 may be displayed in region 154 when one of the categories 156, 157, 158, 159 is selected. The travel search query used to generate the web page 150 may be supplied by the travel service provider, rather than the customer, and then displayed to the customer for further investigation by the customer. In other words, the web page 150 may not be generated by customer interaction, but may be used by the travel service provider to entice a customer to initiate further investigation of the featured results. The appearance and information content of the travel recommendation 160 may be similar or identical to the travel recommendations in the representative embodiment of FIG. 4, may have a simplified appearance and information content in comparison with the travel recommendations in the representative embodiment of FIG. 4, or may have a different appearance with regard to appearance and displayed information.

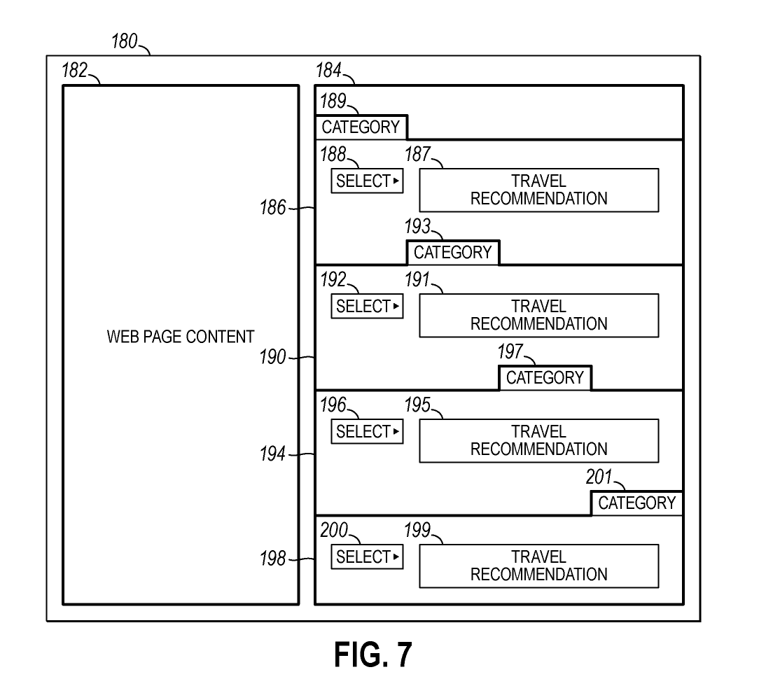

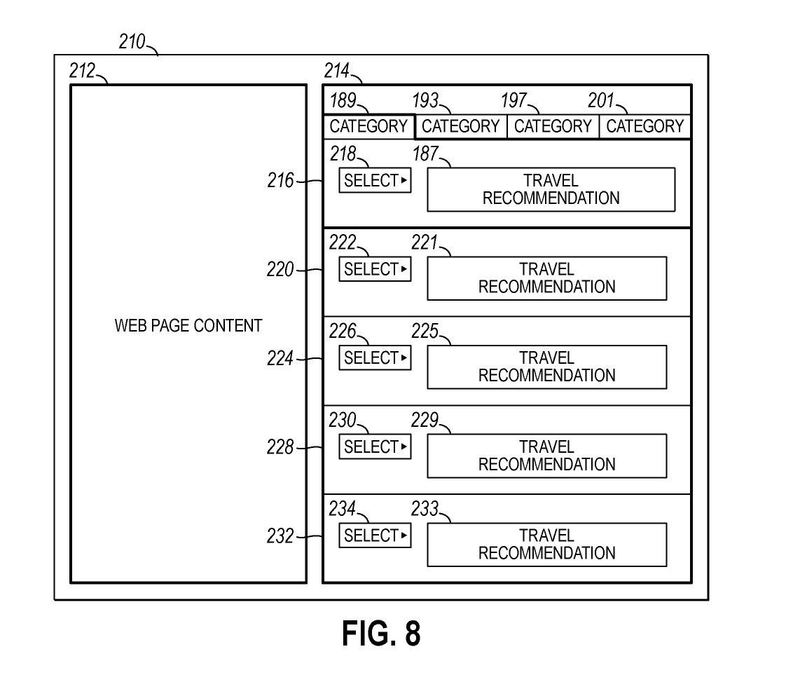

With reference to FIGS. 6-8, a web page 170 (FIG. 6) includes content 172 and a form 174 with controls 176 that permit a user of the form 174 to enter a travel search query in order to initiate the selection algorithm described hereinabove. A select button 176 may be used to communicate the selections populating the controls 176 as data to the search platform 62. A web page 180 (FIG. 7) may be used to present the featured results from the travel search query to the form user. The web page 180 includes content 182 and a region 184 with a plurality of windows 186, 190, 194, 198 in which featured results are displayed. Window 186 displays a travel recommendation 187 belonging to a category 189 and a select button 188 associated with the travel recommendation 187. Window 190 displays a travel recommendation 191 belonging to a category 193 and a select button 192 associated with the travel recommendation 191. Window 194 displays a travel recommendations 195 belonging to a category 197 and a select button 196 associated with the travel recommendation 195. Window 198 displays a travel recommendation 199 belonging to a category 201 and a select button 200 associated with the travel recommendation 199. Each of the categories 189, 193, 197, 201 may be different and, preferably, all of the categories 189, 193, 197, 201 are different. The appearance and information content of the travel recommendations 187, 191, 195, 199 may be similar or identical to the travel recommendations in the representative embodiment of FIG. 4, may have a simplified appearance and information content in comparison with the travel recommendations in the representative embodiment of FIG. 4, or may have a different appearance with regard to appearance and displayed information.

A web page 210 may be used to present a set of featured results from selection of one of the categories 189, 193, 197, 201 in FIG. 7, which may represent buttons on web page 180 and a different set of buttons on web page 210. The web page 210 includes content 212 and a region 214 with a plurality of windows 216, 220, 224, 228 in which featured results for the selected single category may be displayed. Window 216 may displays the travel recommendation 187 belonging to category 189 and a select button 218 for selecting the travel recommendation 187 to investigate more details of travel recommendation 187, booking travel recommendation 187, etc. The travel recommendation 187 may represent the top or most relevant recommendation for the category 189. Window 220 may displays another travel recommendation 221 belonging to category 189 and a select button 222 for selecting the travel recommendation 221 to investigate more details of travel recommendation 221, booking travel recommendation 221, etc. Window 224 may displays another travel recommendation 225 belonging to category 189 and a select button 226 for selecting the travel recommendation 225 to investigate more details of travel recommendation 225, booking travel recommendation 225, etc. Window 228 may displays another travel recommendation 229 belonging to category 189 and a select button 230 for selecting the travel recommendation 229 to investigate more details of travel recommendation 229, booking travel recommendation 229, etc. The appearance and information content of the travel recommendations 187, 221, 225, 229 may be similar or identical to the travel recommendations in the representative embodiment of FIG. 4, may have a simplified appearance and information content in comparison with the travel recommendations in the representative embodiment of FIG. 4, or may have a different appearance with regard to appearance and displayed information.

As a result of interaction with the buttons on web pages 180, 210, the user may view simultaneously displayed multiple travel recommendations from a selected one of the categories 189, 193, 197, 201 and, in the representative embodiment, multiple travel recommendations for category 189. In addition, the user can use, for example, the buttons of categories 189, 193, 197, 201 on web page 201 to alternatively display multiple travel recommendations from each of the categories 189, 193, 197, 201.

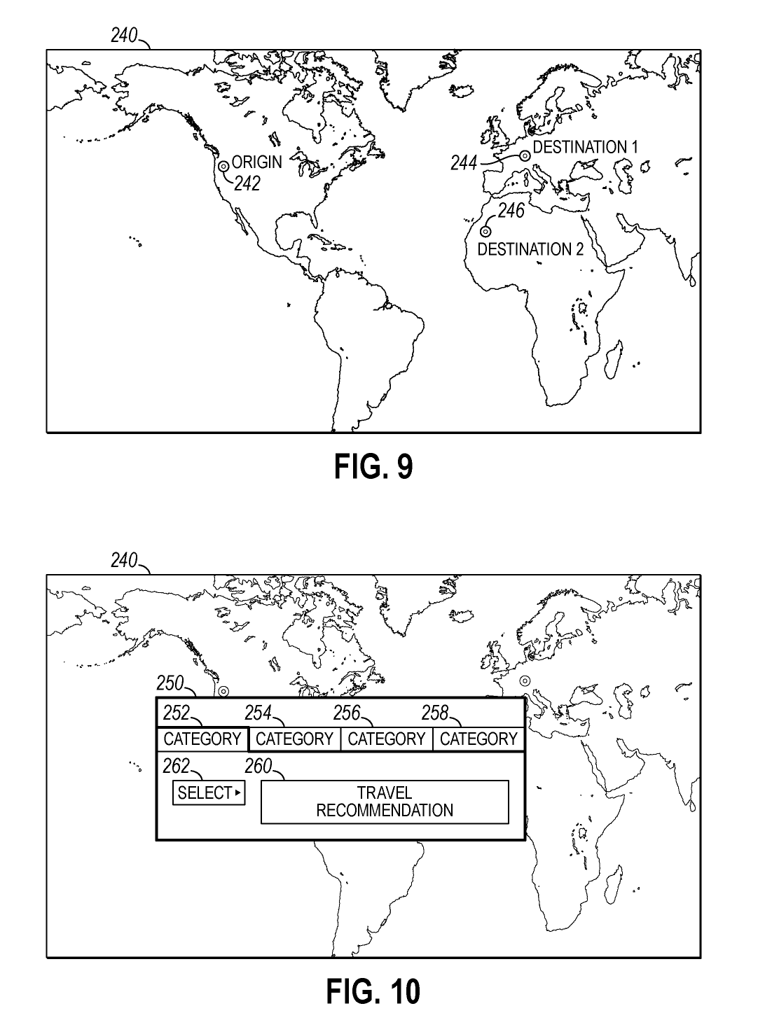

With reference to FIGS. 9 and 10, a web page 240 may be used by a customer to enter a travel search query. In particular, the web page 240 (FIG. 9) may display an origin 242 associated with the user through, for example, a stored profile and a plurality of destinations 244, 246 on a map that comprises a geographical area, such as a global map. When the user selects one or the other of the destinations 244, 246, a window 250 (FIG. 10) may appear in which the user is presented with featured results, which may result from the operation of the selection algorithm of FIG. 3. Alternatively, the featured results may be computed using the selection algorithm and cached for presentation to the user. Specifically, a travel recommendation 260 for one of a plurality of categories 252, 254, 256, 258 is presented to the user in window 250. The categories 252, 254, 256, 258 may represent buttons that can be used to change the category and thereby change the displayed travel recommendation 260 to reflect the selected category. A select button 262 may be used to pick the displayed travel recommendation 260. The appearance and information content of the travel recommendation 260 may be similar or identical to the travel recommendations in the representative embodiment of FIG. 4, may have a simplified appearance and information content in comparison with the travel recommendations in the representative embodiment of FIG. 4, or may have a different appearance with regard to appearance and displayed information.

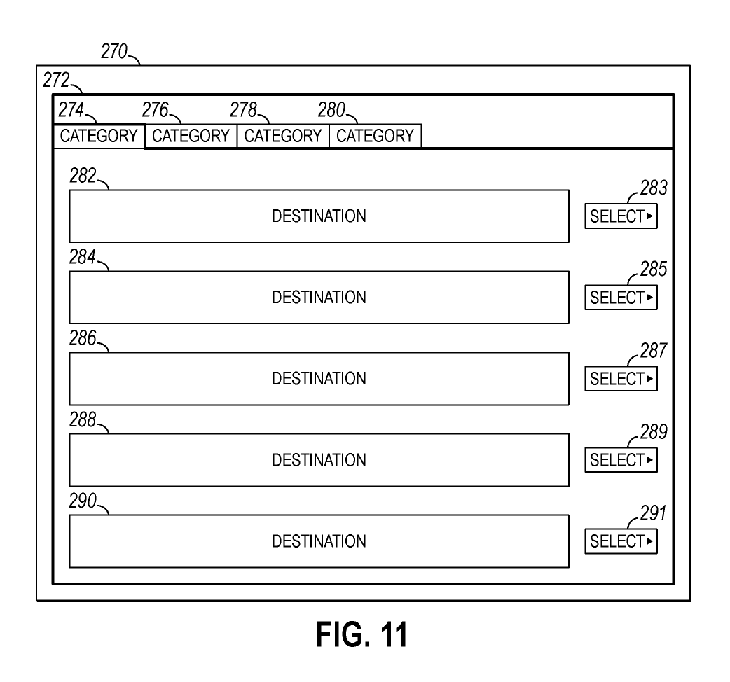

With reference to FIG. 11, a customer may use the web page 240 in a different manner to enter a travel search query. Specifically, the customer may select a button associated with the origin 242 in order to display a selection of destinations 282, 284, 286, 288, 290 in a window 272 of a web page 270. The displayed destinations 282, 284, 286, 288, 290 are derived from travel recommendations for featured results computed as described hereinabove. The displayed destinations 282, 284, 286, 288, 290 correspond to travel recommendations for one of a plurality of categories 274, 276, 278, 280. The categories 274, 276, 278, 280 may represent buttons that can be used to change the selected one of the categories 274, 276, 278, 280 and thereby change the displayed set of destinations 282, 284, 286, 288, 290 to reflect the selected category. Select buttons 283, 285, 287, 289, 291 may be used to pick a corresponding one of destinations 282, 284, 286, 288, 290 in order to display the associated travel recommendation for additional action. The appearance and information content of the destinations 282, 284, 286, 288, 290 may be similar or identical to the travel recommendations in the representative embodiment of FIG. 4, may have a simplified appearance and information content in comparison with the travel recommendations in the representative embodiment of FIG. 4, or may have a different appearance with regard to appearance and displayed information.

The program code embodying any of the embodiments of the invention described herein is capable of being individually or collectively distributed as a program product in a variety of different forms. In particular, the program code may be distributed using a computer readable media, which may include computer readable storage media and communication media. Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures, or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

The methods described herein can be implemented by computer program instructions supplied to the processor of any type of computer to produce a machine with a processor that executes the instructions to implement the functions/acts specified herein. These computer program instructions may also be stored in a computer readable medium that can direct a computer to function in a particular manner. To that end, the computer program instructions may be loaded onto a computer to cause the performance of a series of operational steps and thereby produce a computer implemented process such that the executed instructions provide processes for implementing the functions/acts specified herein.

In addition, program code described herein may be identified based upon the application or software component within which the program code is implemented in a specific embodiment of the invention. However, it should be appreciated that any particular program nomenclature that follows is used merely for convenience, and thus the invention should not be limited to use solely in any specific application identified and/or implied by such nomenclature. It should be further appreciated that the various features, applications, and devices disclosed herein may also be used alone or in any combination. Moreover, given the typically endless number of manners in which computer programs may be organized into routines, procedures, methods, modules, objects, and the like, as well as the various manners in which program functionality may be allocated among various software layers that are resident within a typical computing system (e.g., operating systems, libraries, APIs, applications, applets, etc.), and/or across one or more hardware platforms, it should be appreciated that the invention is not limited to the specific organization and allocation of program functionality described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof Furthermore, to the extent that the terms “includes”, “having”, “has”, “with”, “comprised of”, or variants thereof are used in either the detailed description or the claims, such terms are intended to be inclusive in a manner similar to the term “comprising.”

While embodiments of the invention have been illustrated by a description of various examples, and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. For example, the processing and display of query results may be generally applicable outside of the travel field and may be applicable to categorize and rank the query results for other types of data in which the categories of are defined dependent upon the content of the data. However, the approach to have. Accordingly, departures may be made from such details without departing from the spirit or scope of applicant's general inventive concept.

What is claimed is:

1. A method comprising:
classifying a plurality of database query results at a computer system to populate each of a plurality of categories with a respective given number of the database query results; and
communicating the respective given number of the database query results in each category from the computer system to a client device.

2. The method of claim 1 further comprising:
after classifying the database query results, ranking the database query results at the computer system that populate at least one of the categories.

3. The method of claim 2 wherein ranking the database query results comprises:
sorting the database query results in the at least one of the categories according to popularity.

4. The method of claim 3 wherein the popularity comprises probabilities derived from a statistics server comprising historical sales data, historical booking data, historical ticketing data, or historical demand data.

5. The method of claim 1 wherein each of the database query results in one of the categories comprises an elapsed time, and classifying the database query results comprises:
providing one or more database query results in the category with the elapsed time that is shortest from among the database query results in the category.

6. The method of claim 1 wherein each of the database query results in one of the categories comprises a historical popularity of booking or a historical popularity of ticketing, and classifying the database query results comprises:
identifying one or more database query results in the category with the historical popularity of booking or the historical popularity of ticketing that is highest from among the database query results in the category.

7. The method of claim 1 wherein each of the database query results in one of the categories comprises an exclusive offer, and classifying the database query results comprises:
identifying one or more database query results in the category with a historical popularity of booking or a historical popularity of ticketing that is highest from among the database query results in the category.

8. The method of claim 1 wherein each of the database query results in one of the categories comprises cost, and classifying the database query results comprises:
identifying one or more database query results in the category with the cost that is the lowest from among the database query results in the category.

9. The method of claim 1 wherein each of the database query results in one of the categories comprises a booking time, and classifying the database query results comprises:
identifying one or more database query results in the category with the booking time that is most recent from among the database query results of the first category.

10. The method of claim 1 wherein each of the database query results in one of the categories comprises a sponsorship, and classifying the database query results comprises:
identifying one or more database query results in the category with a historical popularity of booking or a historical popularity of ticketing that is highest from among the database query results in the category.

11. The method of claim 1 wherein the given number of database query results in each category is unity.

12. The method of claim 1 further comprising:
displaying the highest-ranked database query results for each category on a web page.

13. The method of claim 1 further comprising:
determining a sense-of-urgency indicator for at least one result of at least one of the categories; and
providing the sense-of-urgency indicator to the client device in association with the at least one result.

14. The method of claim 1 wherein the database query results are communicated from the computer system to the client device based upon receipt of a travel search query.

15. A computer program product, comprising:
a computer readable storage medium; and
program instructions stored on the computer readable storage medium that, when executed by a processor, cause the processor to execute the method of claim 1.

16. A system, comprising:
a processor; and
program code configured to be executed by the processor to cause the processor to classify a plurality of database query results to populate each of a plurality of categories with a respective given number of the database query results, and to communicate the respective given number of the database query results in each category from the computer system to a client device.

17. The system of claim 16 wherein the program code further causes the processor to, after the database query results are classified, rank the database query results populating at least one of the categories.

18. The system of claim 17 wherein the program code further causes the processor to rank the database query results comprise instructions that cause the processor to sort the database query results in the at least one of the categories according to popularity.

19. The system of claim 16 wherein each of the database query results in one of the categories comprises an elapsed time, and the program code that causes the processor to classify the database query results comprises program code that causes the processor to provide one or more database query results in the category with the elapsed time that is shortest from among the database query results in the category.

20. The system of claim 16 wherein each of the database query results in one of the categories comprises a historical popularity of booking or a historical popularity of ticketing, and the program code that causes the processor to classify the database query results comprises program code that causes the processor to identify one or more database query results in the category with the historical popularity of booking or the historical popularity of ticketing that is highest from among the database query results in the category.

21. The system of claim 16 wherein each of the database query results in one of the categories comprises an exclusive offer, and the program code that causes the processor to classify the database query results comprises program code that causes the processor to identify one or more database query results in the category with a historical popularity of booking or a historical popularity of ticketing that is highest from among the database query results in the category.

22. The system of claim 16 wherein each of the database query results in one of the categories comprises cost, and the program code that causes the processor to classify the database query results comprises program code that causes the processor to identify one or more database query results in the category with the cost that is the lowest from among the database query results in the category.

23. The system of claim 16 wherein each of the database query results in one of the categories comprises a booking time, and the program code that causes the processor to classify the database query results comprises program code that causes the processor to identify one or more database query results in the category with the booking time that is most recent from among the database query results of the first category.

24. The system of claim 16 wherein each of the database query results in one of the categories comprises a sponsorship, and the program code that causes the processor to classify the database query results comprises program code that causes the processor to identify one or more database query results in the category with a historical popularity of booking or a historical popularity of ticketing that is highest from among the database query results in the category.

25. The system of claim 16 further comprising:
program code that causes the processor to determine a sense-of-urgency indicator for the at least one result and to provide the sense-of-urgency indicator in association with the at least one of the database query results.

26. The system of claim 16 further comprising:
a client device in communication with the processor, the client device configured to forward a travel search query to the processor and to receive the given number of the database query results in each category from the processor in response to the travel search query, and the client device including a display configured to present the database query results for each category on a web page.
